(19) United States
(12) Patent Application Publication
(10) Pub. No.: US 2025/0016607 A1
(43) Pub. Date: Jan. 9, 2025

(54) SYSTEMS AND METHODS FOR PROVIDING A FRAMEWORK FOR MULTIPLE WIRELESS CAMERAS ASSOCIATED WITH A USER EQUIPMENT DEVICE

(71) Applicant: Verizon Patent and Licensing Inc., Basking Ridge, NJ (US)

(72) Inventors: Bharadwaj Vemuri, Jersey City, NJ (US); Namrata Prakash, Short Hills, NJ (US); Garima Garg, Livingston, NJ (US)

(21) Appl. No.: 18/347,173

(22) Filed: Jul. 5, 2023

(51) Int. Cl. H04W 28/02; H04W 28/24; H04W 72/1268

(52) U.S. Cl. CPC H04W 28/0268; H04W 28/0257; H04W 28/24; H04W 72/1268

(57) ABSTRACT

A system may include one or more devices configured to register a camera device with a core network; assign the camera device to a subscription of a user equipment (UE) device registered with the core network; and assign the camera device to an uplink streaming network slice. The one or more devices may be further configured to assign an uplink streaming video Quality of Service (QOS) class to a data flow sent from the camera device to the core network, wherein the uplink streaming video QoS class guarantees at least one video streaming QoS parameter; and establish the data flow from the camera device to a destination device via the uplink streaming network slice based on the uplink streaming video QoS class.

### BACKGROUND INFORMATION

To satisfy the needs and demands of users of mobile communication devices, providers of wireless communication services continue to improve and expand their networks. One aspect of such improvements includes the development of wireless access networks and options to utilize such wireless access networks. A user may need to manage multiple devices that connect to a cellular wireless network. Managing multiple devices for a user poses various challenges.

### BRIEF DESCRIPTION OF THE DRAWINGS

FIG. 1 illustrates an environment according to an implementation described herein;

FIG. 2 is a diagram illustrating exemplary components of a Fifth Generation (5G) core network according to an implementation described herein;

FIG. 3 illustrates exemplary components of a device that may be included in a component of an environment according to an implementation described herein;

FIG. 4 illustrates exemplary components of a user equipment (UE) device according to an implementation described herein;

FIGS. 5A and 5B illustrate exemplary components of a camera device according to an implementation described herein;

FIG. 6 illustrates exemplary components of a video management system according to an implementation described herein;

FIG. 7 illustrates a flowchart for configuring a camera to stream video according to an implementation described herein;

FIG. 8 illustrates a flowchart for controlling a camera according to an implementation described herein;

FIG. 9 illustrates a flowchart for establishing a connection from a camera to a core network according to an implementation described herein;

FIG. 10 illustrates a flowchart for managing multiple video stream according to an implementation described herein;

FIG. 11 illustrates an exemplary signal flow according to an implementation described herein; and

FIGS. 12A and 12B illustrate exemplary video streams according to an implementation described herein.

### DETAILED DESCRIPTION OF EMBODIMENTS

The following detailed description refers to the accompanying drawings. The same reference numbers in different drawings identify the same or similar elements.

A cellular wireless network enables user equipment (UE) devices to connect to networks via a Radio Access Network (RAN) and a core network in order to communicate with other devices connected to the RAN, communicate with devices in other networks, access applications or services hosted by a provider in the core network, and/or make use of other types of communication services. For example, a UE device may use enhanced Mobile Broadband (eMBB) services for Voice over Internet Protocol (VOIP) telephone calls and/or data sessions for accessing Internet websites, use massive Internet of Things (mIoT) communication as an IoT device, use Ultra-Reliable Low Latency Communication (URLLC) for mission critical low latency communication, etc. Each type of communication service may be associated with a different set of requirements.

An important feature of next generation cellular wireless network, such as, for example, a Fifth Generation (5G) network, used to meet requirements for different types of communication services, is network slicing. Network slicing is a form of virtual network architecture that enables multiple logical networks to be implemented on top of a common shared physical infrastructure using software defined networking (SDN) and/or network function virtualization (NFV). Each logical network, referred to as a “network slice,” may encompass an end-to-end virtual network with dedicated storage and/or computation resources. Each network slice may be configured to implement a different set of requirements and/or priorities and/or may be associated with a particular Quality of Service (QOS) class, type of service, security requirement, and/or particular enterprise customer associated with a set of user equipment (UE) devices. For example, a 5G network may include an eMBB network slice, an mIoT network slice, a URLLC network slice, etc.

A user of cellular wireless communication may stream video from a camera. For example, a user may stream a video from the user's smart phone, via a cellular wireless connection to a core network via a RAN. However, many use cases call for the use of multiple cameras with different fields of view. For example, a social media influencer may stream video to followers using multiple cameras that have different fields of view, such as a front view of the user, a close-up view of the user's hands, a top view of the user, a side view of the user, etc. Other use cases for multiple cameras with different fields of view include live video streaming of a sporting event, body and/or vehicle cameras for personal security, vehicle cameras for collision detection and avoidance, etc.

Using multiple cameras poses various challenges. For example, a user may need to individually configure each camera. Furthermore, the user may need to either set up wireless communication services subscription for each camera or stream video from the cameras through the user's UE device. Moreover, network slices, such as, for example, an eMBB network slice, and/or Quality of Service (QOS) classes implemented in a network slice, may not be optimized for uplink streaming from a UE device to a provider's core network. For example, a video streaming QoS class may be defined with a high throughput for downlink video streaming and a low throughput for uplink video streaming, since most users may be streaming video from a content provider to a UE device.

Implementations described herein relate to systems and methods for providing a framework for multiple remote cameras associated with a UE device. The framework may include a core network and RAN with an uplink streaming network slice with one or more guaranteed key performance indicators (KPIs) for uplink streaming. Furthermore, the uplink streaming network slice may include an uplink streaming QoS class with one or more guaranteed KPIs for uplink streaming and a downlink streaming QoS class with one or more guaranteed KPIs for downlink streaming of a video stream that combines multiple uplink streams.

Furthermore, the framework may enable multiple cameras, each with a cellular wireless connection, to be assigned to a subscription associated with a UE device. For example, each camera may include a cellular wireless transceiver to connect to a core network via a RAN, a short-range wireless transceiver (e.g., a Bluetooth transceiver, etc.) to communicate with a UE device (e.g., a smart phone, etc.), and an embedded Subscriber Identity Module (eSIM). A user may activate the camera via the UE device and send a request to a provider's core network to activate and register the camera.

One or more devices in the core network may be configured to register the camera with the core network, assign the camera to the subscription of the UE device, and assign the camera to the uplink streaming network slice. Furthermore, an Over-The-Air (OTA) update may be performed on the eSIM of the camera to update the eSIM with authentication credentials to register with the core network. In order to establish a communication session, the camera may establish a Protocol Data Unit (PDU) session in the network slice in the core network via the RAN. The camera may then establish a data flow in the PDU session. The core network may assign an uplink streaming video QoS class to the data flow that guarantees at least one video streaming QoS parameter based on a downlink streaming video requirement and establish the data flow based on the uplink streaming video QoS class.

The user may activate and register multiple cameras and each of the multiple cameras may be assigned to the subscription associated with the user's UE device. A video management system may be configured to receive video streams from the multiple cameras and store each video stream in a video folder associated with the UE device and may be accessible via UE device. Furthermore, the user may, via the UE device, send a control action instruction to the video management system and the video management system may perform a control action in response receiving the control action instruction.

The control action may include, for example, combining multiple uplink video streams into a combined video stream, streaming the combined video stream to one or more UE devices via a downlink video stream, selecting a primary stream from the multiple video streams and increasing a size of a display window for the primary stream in the combined video stream, adjust the size of a window for displaying a particular video stream in the combined video stream, generating a highlight reel for the combined video stream, and/or another type of control action.

In some implementations, the control action may be performed based on user behavior. For example, the video management system may use a trained machine learning model to monitor user behavior, identify a user trigger action based on the monitored user behavior, and perform a control action based on the identified user trigger action. For example, the video management system may select the primary video stream based on the user's movements and/or words spoken by the user.

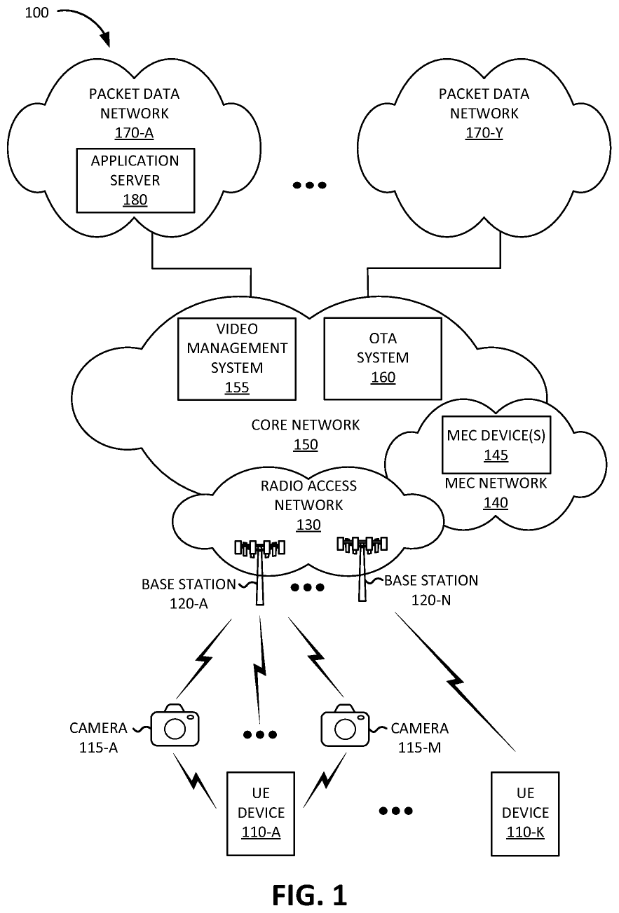

FIG. 1 is a diagram of an exemplary environment 100 in which the systems and/or methods described herein may be implemented. As shown in FIG. 1, environment 100 may include UE devices 110-A to 110-K (referred to herein collectively as “UE devices 110” and individually as “UE device 110”), cameras 115-A to 115-M (referred to herein collectively as “cameras 115” and individually as “camera 115”), base stations 120-A to 120-N (referred to herein collectively as “base stations 120” and individually as “base station 120”) in RAN 130, MEC network 140 (which includes MEC devices 145), core network 150, OTA system 160, and packet data networks (PDNs) 170-A to 170-Y (referred to herein collectively as “PDNs 170” and individually as “PDN 170”).

UE device 110 may include any device with cellular wireless communication functionality. For example, UE device 110 may include a handheld wireless communication device (e.g., a mobile phone, a smart phone, a tablet device, etc.); a wearable computer device (e.g., a head-mounted display computer device, a head-mounted camera device, a wristwatch computer device, etc.); a laptop computer, a tablet computer, or another type of portable computer; a desktop computer; a customer premises equipment (CPE) device, such as a set-top box or a digital media player (e.g., Apple TV, Google Chromecast, Amazon Fire TV, etc.), a Wi-Fi® access point, a fixed wireless access device, a smart television, etc.; a portable gaming system; a global positioning system (GPS) device; a home appliance device; a home monitoring device; and/or any other type of computer device with wireless communication capabilities. In some implementations, UE device 110 may communicate using machine-to-machine (M2M) communication, such as Machine Type Communication (MTC), and/or another type of M2M communication for IoT applications. UE device 110 may be associated with one or more cameras 115. UE device 110 may include a connected cameras application configured to control cameras 115.

Camera 115 may include one or more cameras and a microphone to capture images and/or audio and generate a video stream based on the captured images and/or audio. Camera 115 may include a cellular wireless transceiver configured to connect to base station 120 and/or a short-range wireless transceiver (e.g., a Bluetooth transceiver, etc.) to communicate with UE device 110. Camera 115 may be assigned to a subscription for UE device 110 and video streams generated by camera 115 may be stored in a storage location assigned to the subscription for UE device 110 and be accessible via UE device 110. Camera 115 may stream video to core network 150 and forwarded from core network 150 to other destinations, such as downlink UE devices 110. Camera 115 and/or a video stream generated by camera 115 may be controlled by UE device 110.

RAN 130 may include base stations 120. Base station 120 may be configured for one or more Radio Access Technology (RAT) types. For example, base station 120 may include a 5G New Radio (NR) base station (e.g., a gNodeB) and/or a Fourth Generation (4G) Long Term Evolution (LTE) base station (e.g., an eNodeB). Each base station 120 may include devices and/or components that enable cellular wireless communication with UE devices 110. For example, base station 120 may include a radio frequency (RF) transceiver configured to communicate with UE devices 110 using a 5G NR air interface, a 4G LTE air interface, and/or using another type of cellular air interface. Base station 120 may enable UE device 110 to communicate with core network 150.

MEC network 140 may be associated with one or more base stations 120 and may provide MEC services for UE devices 110 attached to the base stations 120. MEC network 140 may be in proximity to base stations 120 from a geographic and network topology perspective, thus enabling low latency services to be provided to UE devices 110. As an example, MEC network 140 may be located at the same cell site as base station 120. As another example, MEC network 140 may be geographically closer to one of base stations 120 and reachable via fewer network hops and/or fewer switches, than other base stations 120.

MEC network 140 may include one or more MEC devices 145. MEC devices 145 may provide MEC services to UE devices 110. A MEC service may include, for example, a low-latency microservice associated with a particular application, such as, for example, a user authentication microservice, a navigation microservice, an online shopping microservice, a content delivery microservice, a gaming microservice, a virtual and/or augmented reality microservice, a health monitoring microservice, and/or another type of microservice. As another example, a MEC service may include a microservice associated with a virtualized network function (VNF) of core network 150. As yet another example, a MEC service may include a cloud computing service, such as cache storage service, artificial intelligence (AI) accelerator service, machine learning service, an image processing service, a data compression service, a locally centralized gaming service, a Graphics Processing Units (GPUs) and/or other types of hardware accelerator service, and/or other types of cloud computing services. As yet another example, MEC device 145 may receive, store, control, and/or otherwise manage video streams generated by camera 115.

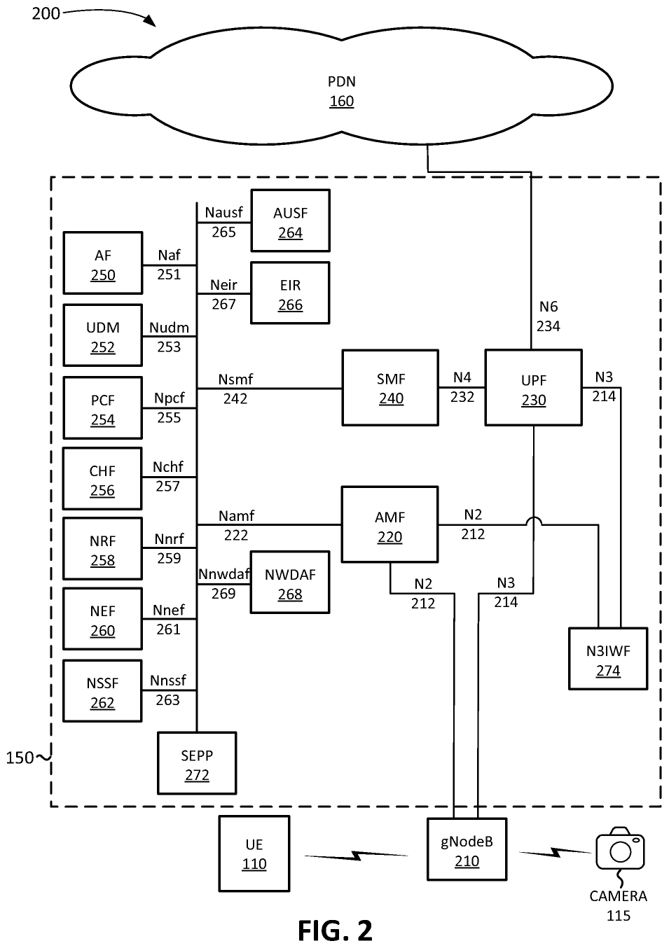

Core network 150 may be managed by a provider of cellular wireless communication services and may manage communication sessions of subscribers connecting to core network 150 via RAN 130. For example, core network 150 may establish an Internet Protocol (IP) connection between UE devices 110 and PDN 170. In some implementations, core network 150 may include a 5G core network. Exemplary components of a 5G core network are described below with reference to FIG. 2. In other implementations, core network 150 may include a 4G core network (e.g., an evolved packet core (EPC) network) and/or another type of core network.

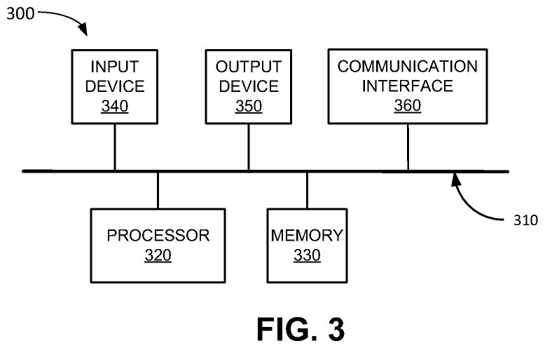

The components of core network 150 may be implemented as dedicated hardware components or as virtualized functions implemented on top of a common shared physical infrastructure using Software Defined Networking (SDN). For example, an SDN controller may implement one or more of the components of core network 150 using an adapter implementing a virtual network function (VNF) virtual machine, a Cloud Native Function (CNF) container, an event driven serverless architecture interface, and/or another type of SDN component. The common shared physical infrastructure may be implemented using one or more devices 300 described below with reference to FIG. 3 in a cloud computing center associated with core network 150. Additionally, or alternatively, some, or all, of the shared physical infrastructure may be implemented using one or more devices 300 implemented in MEC device 145 in MEC network 140.

Core network may include a video management system (VMS) 155 and OTA system 160. VMS 155 may include one or more computer devices, such as server devices, configured to register cameras 115 with core network 150, assign cameras 115 to a subscription associated with UE device 110, assign cameras 115 to an uplink streaming network slice, and/or enable UE device 110 to control video streams generated by cameras 115. VMS 155 may manage video streams generated by cameras 115 and/or by UE device 110 based on instructions received from UE device 110, store video data from received video streams in a storage location associated with UE device 110, combine received video streams from cameras 115 into a combined video stream and stream the combined video stream to destinations, such as downlink UE devices 110, and/or perform other types of actions on the video streams.

OTA system 160 may perform OTA updates on eSIMs in devices (e.g., cameras 115). For example, when a user selects to activate camera 115 via UE device 110, UE device 110 may send a request to VMS 155 to activate and register camera 115, and VMS 155 may instruct OTA system 160 to perform an OTA update on camera 115. The OTA update may update the eSIM on camera 115 with a UE ID for camera 115, with subscription information for UE device 110, credentials for registering with RAN 130 and/or core network 150, and/or other types of information that may be needed to activate and register camera 115.

PDNs 170-A to 170-Y may each include a PDN. A particular PDN 170 may be associated with a Data Network Name (DNN) in 5G, and/or an Access Point Name (APN) in 4G. A UE device may request a connection to PDN 170 using a DNN or an APN. PDN 170 may include, and/or be connected to, a local area network (LAN), a wide area network (WAN), a metropolitan area network (MAN), an autonomous system (AS) on the Internet, an optical network, a cable television network, a satellite network, a wireless network (e.g., a CDMA network, a general packet radio service (GPRS) network, and/or an LTE network), an ad hoc network, a telephone network (e.g., the Public Switched Telephone Network (PSTN) or a cellular network), an intranet, or a combination of networks.

PDN 170 may include an application server 180 (shown in PDN 160-A in FIG. 1 for illustrative purposes). Application server 180 may provide services for an application running on UE device 110 and/or camera 115 may establish an application session with UE device 110 via RAN 130 and core network 150. RAN 130 and core network 150 may establish a communication session or data flow between UE device 110 and application server 180 and maintain a service requirement associated with the communication session or data flow. For example, in some implementations, some or all of the functionality of VMS 155 may be performed by application server 180.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

FIG. 2 illustrates a system 200 that includes exemplary components of core network 150 in the context of environment 100 according to an implementation described herein. As shown in FIG. 2, system 200 may include UE device 110, camera 115, gNodeB 210, core network 150, and PDN 160.

gNodeB 210 (corresponding to base station 120) may include devices (e.g., base stations) and components that enable UE device 110 to connect to core network 150 via RAN 130 using 5G NR RAT. For example, gNodeB 210 may service one or more cells, with each cell being served by a wireless transceiver with an antenna array configured for mm-wave wireless communication. gNodeB 210 may communicate with AMF 220 using an N2 interface 212 and communicate with UPF 230 using an N3 interface 214.

Core network 150 may include an AMF 220, a User Plane Function (UPF) 230, a Session Management Function (SMF) 240, an AF 250, a Unified Data Management (UDM) 252, a Policy Control Function (PCF) 254, a Charging Function (CHF) 256, a Network Repository Function (NRF) 258, a Network Exposure Function (NEF) 260, an NSSF 262, an Authentication Server Function (AUSF) 264, a 5G Equipment Identity Register (EIR) 266, an NWDAF 268, a Security Edge Protection Proxy (SEPP) 272, and a Non-3GPP Inter-Working Function (N3IWF) 274.

While FIG. 2 depicts a single AMF 220, UPF 230, SMF 240, AF 250, UDM 252, PCF 254, CHF 256, NRF 258, NEF 260, NSSF 262, AUSF 264, EIR 266, NWDAF 268, SEPP 272, and N3IWF 274 for illustration purposes, in practice, core network 150 may include multiple AMFs 220, UPFs 230, SMFs 240, AFs 250, UDMs 252, PCFs 254, CHFs 256, NRFs 258, NEFs 260, NSSFs 262, AUSFs 264, EIRs 266, NWDAFs 268, SEPPs 272, and/or N3IWFs 274.

For example, in some implementations, some or all of AMF 220, UPF 230, SMF 240, AF 250, UDM 252, PCF 254, CHF 256, NRF 258, NEF 260, NSSF 262, AUSF 264, EIR 266, NWDAF 268, SEPP 272, and N3IWF 274 may be logically partitioned into different network slices, and/or include multiple instances deployed on different physical infrastructure associated with different network slices, including an uplink streaming network slice. An uplink streaming network slice may reserve network resources and configure NFs to guarantee one or more QoS parameters for uplink video streaming, such as, for example, a guaranteed throughput for uplink video streaming, a guaranteed latency for uplink video streaming, a guaranteed jitter for uplink video streaming, a guaranteed maximum packet loss rate for uplink video streaming, a guaranteed minimum number of video streaming connections for uplink video streaming for a subscription, and/or other QoS parameters. Additionally, the uplink streaming network slice may reserve resources and configure NFs for downlink multicast streaming to guarantee one or more QoS parameters for downlink video streaming, such as, for example a guaranteed throughput for downlink video streaming, a guaranteed latency for downlink video streaming, a guaranteed jitter for downlink video streaming, a guaranteed maximum packet loss rate for downlink video streaming, a guaranteed minimum number of video streaming connections for downlink video streaming, and/or other QoS parameters.

AMF 220 may perform registration management, connection management, reachability management, mobility management, lawful intercepts, session management messages transport between UE device 110, and/or camera 115, and SMF 240, access authentication and authorization, location services management, functionality to support non-3GPP access networks, and/or other types of management processes. AMF 220 may be accessible by other function nodes via an Namf interface 222.

UPF 230 may maintain an anchor point for intra/inter-RAT mobility, maintain an external Protocol Data Unit (PDU) point of interconnect to a particular data network (e.g., PDN 160), perform packet routing and forwarding, perform the user plane part of policy rule enforcement, perform packet inspection, perform lawful intercept, perform traffic usage reporting, perform QoS handling in the user plane, perform uplink traffic verification, perform transport level packet marking, perform downlink packet buffering, forward an “end marker” to a RAN node (e.g., gNodeB 210), and/or perform other types of user plane processes. UPF 230 may communicate with SMF 240 using an N4 interface 232 and connect to PDN 160 using an N6 interface 234.

SMF 240 may perform session establishment, session modification, and/or session release, perform IP address allocation and management, perform Dynamic Host Configuration Protocol (DHCP) functions, perform selection and control of UPF 230, configure traffic steering at UPF 230 to guide the traffic to the correct destinations, terminate interfaces toward PCF 254, perform lawful intercepts, charge data collection, support charging interfaces, control and coordinate charging data collection, terminate session management parts of Non-Access Stratum (NAS) messages, perform downlink data notification, manage roaming, and/or perform other types of control plane processes for managing user plane data. SMF 240 may be accessible via an Nsmf interface 242.

AF 250 may provide services associated with a particular application, such as, for example, an application for influencing traffic routing, an application for accessing NEF 260, an application for interacting with a policy framework for policy control, and/or other types of applications. AF 250 may be accessible via an Naf interface 251, also referred to as an NG5 interface. In some implementations, AF 250 may correspond to, or interface with application server 180.

UDM 252 may maintain subscription information for UE devices 110 and/or cameras 115 in a Unified Data Repository (UDR), manage subscriptions, generate authentication credentials, handle user identification, perform access authorization based on subscription data, perform network function registration management, maintain service and/or session continuity by maintaining assignment of SMF 240 for ongoing sessions, support SMS delivery, support lawful intercept functionality, and/or perform other processes associated with managing user data. UDM 252 may store information associating one or more cameras 115 with UE device 110. For example, UDM 252 may assign camera 115 to a subscription account associated with UE device 110. Furthermore, UDM 252 may store information indicating that camera 115 should be admitted to an uplink streaming network slice and/or that data flows for a PDU session from camera 115 to core network 150 (e.g., to UPF 230, etc.) should be assigned to an uplink video streaming QoS class. UDM 252 may be accessible via a Nudm interface 253.

PCF 254 may support policies to control network behavior, provide policy rules to control plane functions (e.g., to SMF 240), access subscription information relevant to policy decisions, perform policy decisions, and/or perform other types of processes associated with policy enforcement. PCF 254 may assign a QoS class to a data flow associated with a PDU session and provide a QoS class ID (QCI), such as a 5G QCI (5QI), to UPF 230 associated with the data flow and/or to transport network elements in RAN 130 (e.g., a Central Unit Control Plane (CU-CP), etc.). PCF 254 may be accessible via Npcf interface 255. CHF 256 may perform charging and/or billing functions for core network 150. CHF 256 may be accessible via Nchf interface 257.

NRF 258 may support a service discovery function and maintain profiles of available network function (NF) instances and their supported services. An NF profile may include, for example, an NF instance ID, an NF type, a PLMN ID associated with the NF, network slice IDs associated with the NF, capacity information for the NF, service authorization information for the NF, supported services associated with the NF, endpoint information for each supported service associated with the NF, and/or other types of NF information. NRF 258 may be accessible via an Nnrf interface 259.

NEF 260 may expose capabilities and events to other NFs, including third party NFs, AFs, edge computing NFs, and/or other types of NFs. Furthermore, NEF 260 may secure provisioning of information from external applications to core network 150, translate information between core network 150 and devices/networks external to core network 150, support a Packet Flow Description (PFD) function, and/or perform other types of network exposure functions. NEF 260 may be accessible via Nnef interface 261.

NSSF 262 may select a set of network slice instances to serve a particular UE device 110 and/or camera 115, determine network slice selection assistance information (NSSAI) or a Single-NSSAI (S-NSSAI), determine a particular AMF 220 to serve a particular UE device 110, and/or perform other types of processing associated with network slice selection or management. NSSF 262 may be accessible via Nnssf interface 263. NSSF 262 may provide a list of allowed slices to AMF 220.

AUSF 264 may perform authentication. For example, AUSF 264 may implement an Extensible Authentication Protocol (EAP) authentication server and may store authentication keys for UE devices 110 and/or cameras 115. AUSF 264 may be accessible via Nausf interface 265. EIR 266 may authenticate a particular UE device 110 and/or camera 115 based on a device identity, such as a Permanent Equipment Identifier (PEI). For example, EIR 266 may check to determine if a PEI has been blacklisted. EIR 266 may be accessible via Neir interface 267.

NWDAF 268 may collect analytics information associated with radio access network 120 and/or core network 150. NWDAF 268 may collect KPI values for different locations for applications running on particular network slices and generate historical performance data based on the collected KPI values. NWDAF 268 may collect the KPI values from UE device 110 and/or camera 115, and/or from UPF 230 via SMF 240.

SEPP 272 may implement application layer security for all layer information exchanged between two NFs across two different PLMNs. N3IWF 274 may interconnect to a non-3GPP access device, such as, for example, a WiFi Access Point. N3IWF 274 may facilitate handovers for UE device 110 between RAN 130 and the non-3GPP access device. N3IWF 274 may be accessible via Nn3iwf interface 275.

Although FIG. 2 shows exemplary components of core network 150, in other implementations, core network 150 may include fewer components, different components, differently arranged components, or additional components than depicted in FIG. 2. Additionally, or alternatively, one or more components of core network 150 may perform functions described as being performed by one or more other components of core network 150. For example, core network 150 may include additional function nodes not shown in FIG. 2, such as an Unstructured Data Storage Network Function (UDSF), a Location Management Function (LMF), a Lawful Intercept Function (LIF), a Binding Session Function (BSF), and/or other types of functions. Furthermore, while particular interfaces have been described with respect to particular function nodes in FIG. 2, additionally, or alternatively, core network 150 may include a reference point architecture that includes point-to-point interfaces between particular function nodes.

FIG. 3 illustrates example components of a device 300 according to an implementation described herein. UE device 110, camera 115, base station 120, MEC device 145, VMS 155, OTA system 160, application server 180, gNodeB 210, AMF 220, UPF 230, SMF 240, AF 250, UDM 252, PCF 254, CHF 256, NRF 258, NEF 260, NSSF 262, AUSF 264, EIR 266, NWDAF 268, SEPP 272, N3IWF 274, and/or other components of core network 150 or RAN 130, may each include one or more devices 300. As shown in FIG. 3, device 300 may include a bus 310, a processor 320, a memory 330, an input device 340, an output device 350, and a communication interface 360.

Bus 310 may include a path that permits communication among the components of device 300. Processor 320 may include any type of single-core processor, multi-core processor, microprocessor, latch-based processor, and/or processing logic (or families of processors, microprocessors, and/or processing logics) that interprets and executes instructions. In other embodiments, processor 320 may include an application-specific integrated circuit (ASIC), a field-programmable gate array (FPGA), and/or another type of integrated circuit or processing logic. Additionally, or alternatively, processor 320 may include a hardware accelerator integrated circuit or processing logic, such as a graphics processing unit (GPU), a tensor processing unit (TPU), and/or another type of hardware accelerator.

Memory 330 may include any type of dynamic storage device that may store information and/or instructions, for execution by processor 320, and/or any type of non-volatile storage device that may store information for use by processor 320. For example, memory 330 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 340 may allow an operator to input information into device 300. Input device 340 may include, for example, a keyboard, a mouse, a pen, a microphone, a remote control, an audio capture device, an image and/or video capture device, a touch-screen display, and/or another type of input device. In some embodiments, device 300 may be managed remotely and may not include input device 340. In other words, device 300 may be “headless” and may not include a keyboard, for example.

Output device 350 may output information to an operator of device 300. Output device 350 may include a display, a printer, a speaker, and/or another type of output device. For example, device 300 may include a display, which may include a liquid-crystal display (LCD) for displaying content to the customer. In some embodiments, device 300 may be managed remotely and may not include output device 350. In other words, device 300 may be “headless” and may not include a display, for example.

Communication interface 360 may include a transceiver that enables device 300 to communicate with other devices and/or systems via wireless communications (e.g., RF, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 360 may include a transmitter that converts baseband signals to RF signals and/or a receiver that converts RF signals to baseband signals. Communication interface 360 may be coupled to one or more antennas/antenna arrays for transmitting and receiving RF signals.

Communication interface 360 may include a logical component that includes input and/or output ports, input and/or output systems, and/or other input and output components that facilitate the transmission of data to other devices. For example, communication interface 360 may include a network interface card (e.g., Ethernet card) for wired communications and/or a wireless network interface (e.g., a WiFi) card for wireless communications. Communication interface 360 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, in some implementations, device 300 may perform certain operations relating to configuring a camera, controlling a camera, establishing a video stream from a camera to a core network, combining video stream from multiple cameras, performing control actions on a camera or a video stream, and/or other operations associated with managing cameras associated with a UE device and/or video streams associated with the cameras. Device 300 may perform these operations in response to processor 320 executing software instructions contained in a computer-readable medium, such as memory 330. A computer-readable medium may be defined as a non-transitory memory device. A memory device may be implemented within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of, or in combination with, software instructions to implement processes described herein. Thus, implementations described herein are not limited to any specific combination of hardware circuitry and software.

Although FIG. 3 shows exemplary components of device 300, in other implementations, device 300 may include fewer components, different components, additional components, or differently arranged components than depicted in FIG. 3. Additionally, or alternatively, one or more components of device 300 may perform one or more tasks described as being performed by one or more other components of device 300.

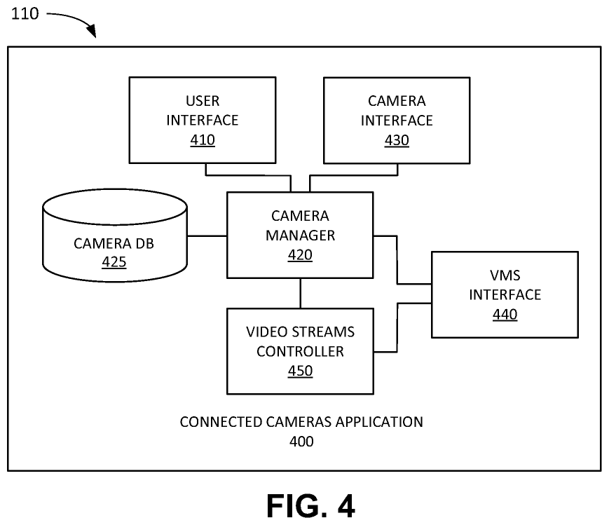

FIG. 4 is a diagram illustrating exemplary components of UE device 110. The components of UE device 110 may be implemented, for example, via processor 320 executing instructions from memory 330. Alternatively, some or all of the components of UE device 110 may be implemented via hard-wired circuitry. As shown in FIG. 4, UE device 110 may include a connected cameras application 400. Connected cameras application 400 may be downloaded by UE device 110 from, for example, VMS 155. Connected cameras application 400 may be configured to communicate with cameras 115 and/or with VMS 155 to manage cameras 115 and/or video streams generated by cameras 115. Connected cameras application 400 may include a user interface 410, a camera manager 420, a camera database (DB) 425, a camera interface 430, a VMS interface 440, and a video streams controller 450.

User interface 410 may enable a user to of UE device 110 to interact with connected cameras application 400. For example, user interface 410 may enable the user to activate a camera on UE device 110 to scan a code on camera 115 to activate a camera. Furthermore, user interface 410 may include selection objects (e.g., menus, buttons, text boxes, etc.) to enable the user to control cameras 115 and/or video streams generated by cameras 115. Additionally, user interface 410 may be configured to receive, interpret, and execute voice commands spoken by the user.

Camera manager 420 may manage cameras 115 assigned to the subscription associated with UE device 110. For example, camera manager 420 may communicate with camera 115 during an activation and/or registration process. Furthermore, camera manager 420 may configure one or more camera operation parameters, such as, for example, which camera to use, whether to use a light source, a type of zoom and/r focus to use, etc.; video streaming parameters for camera 115, such as, for example, resolution, frame rate (e.g., frames per second), encoding profile, etc.; and/or other types of parameters.

Camera DB 415 may store information identifying cameras 115 associated with connected cameras application 400, configurations associated with each camera 115, a current status of each camera 115, and/or other information that may be used by connected cameras application 400 to identify, communicate with, and/or control cameras 115.

Camera interface 430 may be configured to communicate with camera 115. For example, camera interface 430 may use an application programming interface (API) exposed by camera 115 to access and configure camera 115. Additionally, camera interface 430 may receive data from camera 115 related to the operation of camera 115 and/or may receive photos and/or videos captured by camera 115.

VMS interface 440 may be configured to communicate with VMS 155. For example, video streams controller 450 may use VMS interface 440 to use an API exposed by VMS 155 to send instructions to VMS 155. Video streams controller 450 may send a request to VMS 155 to activate camera 115 and/or to register camera 115 with core network 150. The request may include, for example, an identifier (ID) associated with camera 115 (e.g., an International Mobile Equipment Identity (IMEI), etc.), an ID associated with UE device 110 (e.g., a Mobile Directory Number (MDN), an International Mobile Subscriber Identity (IMSI), a Mobile Station International Subscriber Directory Number (MSISDN), an International Mobile Equipment Identity (IMEI), etc.), an ID associated with the subscription for UE device 110 (e.g., a subscription ID, an account number, etc.), information identifying a service to be activated for camera 115 (e.g., a guaranteed throughput, a guaranteed latency, a total amount of data allowed to be transmitted during a billing cycle, etc.), and/or other types of information.

Furthermore, video streams controller 450 may receive input from user interface 410 and generate an instruction to perform a control action for camera 115 and/or a video stream generated by camera 115 and received by VMS 155. For example, video streams controller 450 may send an instruction to VMS 155 to combine multiple uplink video streams into a combined video stream, stream the combined video stream to one or more UE devices 110 via a downlink video stream, select a primary stream from the multiple video stream and increasing a size of a display window for the primary stream in the combined video stream, adjust the size of a window for a video stream in the combined video stream, generate a highlight reel for the combined video stream, and/or to perform another type of control action.

Although FIG. 4 shows exemplary components of connected cameras application 400, in other implementations, connected cameras application 400 may include fewer components, different components, additional components, or differently arranged components than depicted in FIG. 4. Additionally, or alternatively, one or more components of connected cameras application 400 may perform one or more tasks described as being performed by one or more other components of connected cameras application 400.

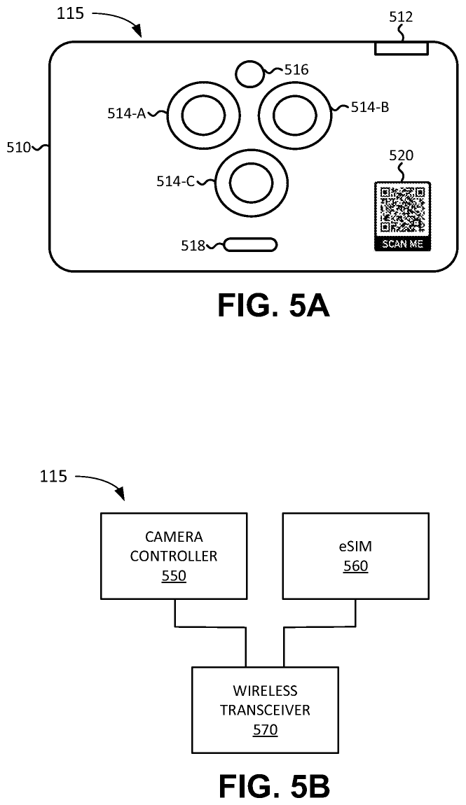

FIGS. 5A and 5B illustrate exemplary components of camera 115. FIG. 5A illustrates exemplary external components of camera 115. As shown in FIG. 5A, camera 115 may include a housing 510, a button 512, camera sensors 514-A, 514-B and 514-C, a light source 516, a microphone 518, and a scannable code 520.

Housing 510 may enclose and protect the components of camera 115 from the environment. Housing 510 may be sized and shaped to conform to a form factor for handheld operation, for being worn on a user's body, for being attached to a portable and/or movable support, etc. Button 512 may turn camera 115 on and off and/or turn video streaming on and off. Camera sensors 514-A, 514-B and 514-C may capture still photos and/or video and may each be associated with a different set of operational parameters, such as aperture size, focal length, zoom, etc. While three different sensors 514 are shown in FIG. 5A, camera 115 may include fewer or additional camera sensors 514. Light source 516 may provide a light source for low light conditions. Microphone 518 may capture audio in connection with the video captured by camera sensors 514.

Scannable code 520 may include a code (e.g., a quick response (QR) code and/or another type of matrix barcode, etc.) that is scannable by a camera on UE device 110 to provide information to UE device 110 to activate and register camera 115. For example, scannable code 520 may include an ID associated with camera 115 and a Uniform Resource Identifier (URI) associated with VMS 155 that causes connected cameras application 400 on UE device 110 to send a request to VMS 155 to activate and register camera 115 when scanned. Additionally, scannable code 520 may cause connected cameras application 400 to pair UE device 110 with camera 115 using a short-range wireless communication standard, such as the Bluetooth standard.

FIG. 5B illustrates exemplary internal components of camera 115. The internal components of camera 115 may be implemented, for example, via processor 320 executing instructions from memory 330. Alternatively, some or all of the internal components of camera 115 may be implemented via hard-wired circuitry. As shown in FIG. 5, camera 115 may include a camera controller 550, an eSIM 560, and a wireless transceiver 570.

Camera controller 550 may control camera sensors 514, light source 516, and/or microphone 518 to capture photos, audio, and/or video based on a configuration for camera 115 selected by UE device 110. eSIM 560 may store information to authenticate and identify camera 115 on RAN 130 and/or core network 150. For example, eSIM 560 may store an Integrated Circuit Card ID (ICCID), an IMEI, an IMSI, an Issuer ID number (IIN), authentication keys, local area identity (LAI), and/or other types of IDS and/or keys. eSIM 560 may be updated by OTA system 160 during an activation process.

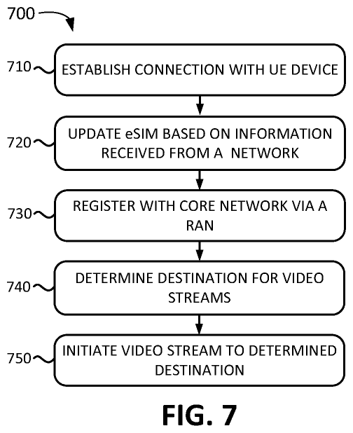

In some implementations, eSIM 560 may include a bootstrap profile to enable one-click activation of camera 115. For example, may press a button on camera 115 (e.g., button 512) to activate camera 115. In response, the bootstrap profile on eSIM 560 may automatically pair with UE device 110, update eSIM 560, register with core network 150 via RAN 130, and determine a destination for streaming video stream, as described below in more detail with reference to FIG. 7.

Wireless transceiver 530 may include a cellular wireless transceiver configured to communicate using a 5G NR air interface, a 4G LTE air interface, and/or another type of cellular wireless air interface. Additionally, wireless transceiver 530 may include a short-range wireless transceiver, such as a Bluetooth transceiver, a WiFi transceiver, and/or another type of short-range wireless transceiver.

Although FIGS. 5A and 5B show exemplary components of camera 115, in other implementations, camera 115 may include fewer components, different components, additional components, or differently arranged components than depicted in FIGS. 5A and 5B. Additionally, or alternatively, one or more components of camera 115 may perform one or more tasks described as being performed by one or more other components of camera 115.

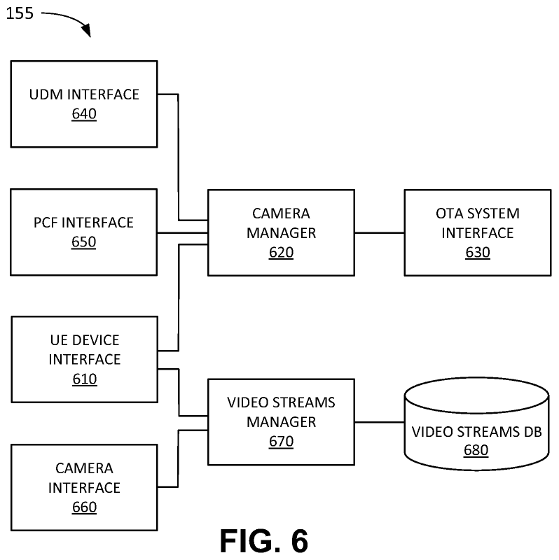

FIG. 6 illustrates exemplary components of VMS 155. The components of VMS 155 may be implemented, for example, via processor 320 executing instructions from memory 330. Alternatively, some or all of the components of VMS 155 may be implemented via hard-wired circuitry. As shown in FIG. 6, VMS 155 may include a UE device interface 610, a camera manager 620, an OTA system interface 630, a UDM interface 640, a PCF interface 650, a camera interface 660, a video streams manager 670, and a video streams DB 680.

UE device interface 610 may be configured to communicate with UE device 110. For example, UE interface 610 may implement an API accessible by connected camera application 400 to request activation and registration of camera 115, to instruct VMS 155 to perform a control action on a generated video stream, to instruct VMS 155 to configure camera 115 and/or a subscription associated with camera 115, and/or to perform other types of actions with respect to camera 115 and/or a video stream associated with camera 115.

Camera manager 620 may manage cameras 115. For example, camera manager 620 may activate and register camera 115. Camera manager 620 may receive a request from UE device 110 to activate camera 115 and instruct OTA system 160, via OTA system interface 630, to update eSIM 560 in camera 115. Furthermore, camera manager 620 may assign, or obtain from another device or system in core network 140, an IMSI, MDN, and/or another type of subscription ID to camera 115 and instruct, via UDM interface 640, UDM 252 to generate a subscription record for camera 115 and assign the subscription for camera 115 to UE device 110. Camera manager 620 may instruct UDM 252 to include the uplink streaming network slice on the allowed network slices list for camera 115. Camera manager 620 may instruct, via PCF interface 650, PCF 254 to generate a policy for camera 115. For example, camera manager 620 may instruct PCF 254 to assign an uplink video streaming QoS class to data flows originated by camera 115.

Camera interface 660 may be configured to communicate with camera 115. For example, camera manager 620 may change a configuration associated with camera 115, such as a parameter associated with camera sensor 514, light source 516, and/or microphone 518 and/or a parameter associated with generating a video stream. Furthermore, camera interface 660 may receive photos, audio streams, and/or video streams from camera 115 and provide the received photos, audio streams, and/or video streams to video streams manager 670.

Video streams manager 670 may manage video streams received from cameras 115. Video streams manager 670 may store photos, audio streams, and/or video streams received from cameras 115 in video streams DB 680 in a folder associated with a subscription for UE device 110 associated with cameras 115. Video streams manager 670 may perform a control action based on an instruction received from UE device 110 (e.g., inputted by a user into connected cameras application 400 via user interface 410), based on a default setting, and/or based on a preconfigured setting associated with UE device 110 and/or camera 115. The control action may include, for example, combining multiple uplink video streams into a combined video stream, streaming the combined video stream to one or more UE devices 110 as a downlink video stream, selecting a primary stream from the multiple video stream and increasing a size of a window for the primary stream in the combined video stream, adjusting the size of a window for a video stream in the combined video stream, generating a highlight reel for the combined video stream, and/or to performing another type of control action.

Video streams manager 670 may monitor user behavior and perform a control action based on user behavior. For example, video streams manager 670 may monitor user movements and/or user speech to identify a trigger action to perform a control action, such as identifying a user trigger action in a video stream to make the video stream the primary stream. In response to making a video stream the primary stream, video streams manager 670 may increase the size of the window for the primary stream in a combined stream of multiple video streams. Video streams manager 670 may use a trained machine learning model, such as, for example, a trained deep learning neural network model, to identify different user trigger actions.

Although FIG. 6 shows exemplary components of VMS 155, in other implementations, VMS 155 may include fewer components, different components, additional components, or differently arranged components than depicted in FIG. 6. Additionally, or alternatively, one or more components of VMS 155 may perform one or more tasks described as being performed by one or more other components of VMS 155.

FIG. 7 illustrates a flowchart of a process 700 for configuring a camera to stream video according to an implementation described herein. In some implementations, process 700 may be performed by camera 115. In other implementations, some or all of process 700 may be performed by another device or a group of devices.

As shown in FIG. 7, process 700 may include establishing a connection with a UE device (block 710). For example, camera 115 may pair with UE device 110 using a short-range wireless communication, such as a Bluetooth communication. Process 700 may further include updating an eSIM based on information received from a network (block 720) and registering with a core network via a RAN (block 730). For example, camera 115 receive an eSIM OTA update from OTA system 160. In some implementations, the OTA update may be received from UE device 110 via the paired connection. In other implementations, camera 115 may connect to base station 120 and receive the OTA update via RAN 130 during registration. After eSIM is updated, camera 115 may receive an instruction from UE device 110 via the paired connection to register with core network 150. In response, camera 115 may send a registration request to AMF 220 and AMF 220 may carry out a registration procedure to register camera 115 with core network 150 and establish a PDU session between camera 115 and a destination that is to receive video stream generated by camera 115.

Process 700 may further include determining a destination for video streams (block 740) and initiating a video stream to the determined destination (block 750). For example, camera 115 may receive information identifying VMS 155 as the destination for video streams generated by camera 115. The information identifying VMS 155 as the destination for video streams may be received from OTA system 160 during an OTA update, from AMF 220 during a registration procedure with core network 150, from connected cameras application 400 on UE device 110, and/or from another source. Camera 115 may, in response to an instruction from UE device 110, or by a user pressing button 512, initiate capture of video and streaming the video via an uplink through RAN 130 and core network 150 to VMS 155 using the established PDU session.

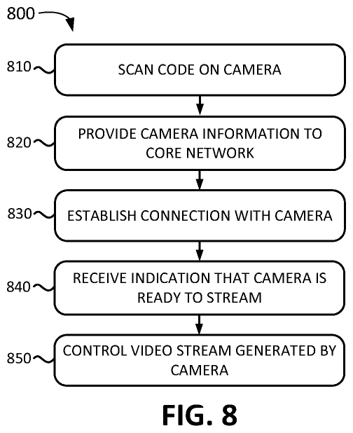

FIG. 8 illustrates a flowchart of a process 800 for controlling a camera according to an implementation described herein. In some implementations, process 800 may be performed by UE device 110. In other implementations, some or all of process 800 may be performed by another device or a group of devices.

As shown in FIG. 8, process 800 may include scanning a code on a camera (block 810), providing camera information to a core network (block 820), and establishing a connection with the camera (block 830). For example, a user may activate connected cameras application 400 and scan scannable code 520. In response, connected cameras application 400 may send a request to VMS 155 to activate and register camera 115 with RAN 130 and/or core network 150. The request may include information identifying camera 115 and UE device 110. Furthermore, UE device 110 may pair with camera 115 using a short-range wireless communication standard, such as a Bluetooth standard.

Process 800 may further include receiving an indication that the camera is ready to stream (block 840) and controlling a video stream generated by the camera (bock 850). For example, connected cameras application 400 may receive an indication from VMS 155 that camera 115 is registered with core network 150 and ready to stream video. The user may then use connected camera application 400 to activate uplink video stream from multiple cameras 115 associated with UE device 110 and may control the video streams by sending instructions to VMS 155.

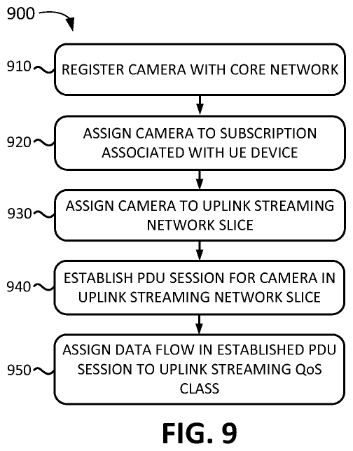

FIG. 9 illustrates a flowchart of a process 900 for establishing a connection from a camera to a core network according to an implementation described herein. In some implementations, process 900 may be performed by one or more devices in core network 150. In other implementations, some or all of process 900 may be performed by another device or a group of devices.

As shown in FIG. 9, process 900 may include registering a camera with a core network (block 910) and assigning the camera to a subscription associated with a UE device (block 920). For example, UDM 252 may receive an instruction from VMS 155 to create a subscription record for camera 115 and to assign the subscription for camera 115 to the subscription for UE device 110. The instruction may include information identifying camera 115 (e.g., an MDN, IMSI, IMEI, MSISDN, and/or another type of ID) and information identifying UE device 110 (e.g., an MDN, IMSI, IMEI, MSISDN, and/or another type of ID). Furthermore, the instruction may include an instruction to include the uplink streaming network slice on the allowed network slices list for camera 115. In response, UDM 252 may generate a subscription record for camera 115 and assign the subscription record to UE device 110.

Process 900 may further include assigning the camera to an uplink streaming network slice (block 930). For example, UDM 252 may add an uplink streaming network slice to the allowed network slices list for camera 115 and indicate in the subscription record for camera 115 that a PDU session for camera 115 should be established in the uplink streaming network slice.

Process 900 may further include establishing a PDU session for the camera in the uplink streaming network slice (block 940) and assigning a data flow in the established PDU session to an uplink streaming QoS class (block 950). For example, camera 115 may send a registration request to AMF 220 and AMF 220 may carry out a PDU session establishment procedure. As part of the PDU session establishment, a default data flow may be created in the established PDU session for uplink streaming of video. For example, PCF 254 may provide policies for the established PDU session and/or created data low to SMF 240 and SMF 240 may apply the provided policies to UPF 230. The provided policies may assign an uplink streaming QoS class (e.g., a 5QI, etc.) to the created data flow.

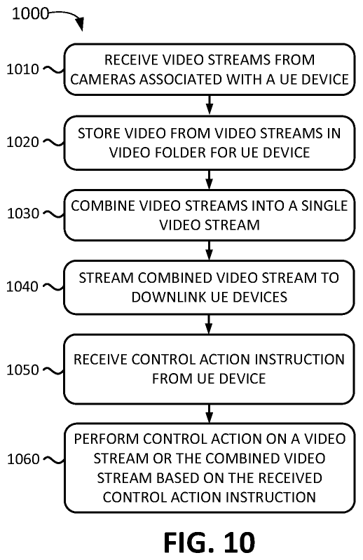

FIG. 10 illustrates a flowchart for managing multiple video streams according to an implementation described herein. In some implementations, process 1000 may be performed by VMS 155. In other implementations, some or all of process 1000 may be performed by another device or a group of devices.

As shown in FIG. 10, process 1000 may include receiving video streams from cameras associated with a UE device (block 1010), storing video from the video streams in a video folder for the UE device (block 1020), and combining the video streams into a single video stream (block 1030). For example, VMS 155 may receive photos, audio, and/or video streams from multiple cameras 115 associated with UE device 110 and store the photos, audio streams, and/or video streams in video streams DB 680 in a folder associated with a subscription for UE device 110. Furthermore, VMS 155 may combine the video stream into a single video stream. For example, VMS 155 may divide a window of the combined video stream into a set of windows of different sizes, with each window including one of the multiple video streams. VMS 155 may select one of the video streams as a primary video stream and the size of the window of the primary video stream may be larger that the sizes of the other windows for the other video streams. In other implementations, the primary video stream may take up the entire size of the display.

Process 1000 may further include streaming the combined video stream to downlink UE devices (block 1040). VMS 155 may host a streaming server that streams the combined video stream to downlink UE devices 110. For example, a downlink UE device 110 may navigate to a website hosted by the streaming server, select a channel associated with the user of cameras 115 generating the combined video stream, and select to stream a downlink video stream to the user's downlink UE device 110. Alternatively, the downlink UE device 110 may include an application that, upon activation, enables the user to select to stream a downlink video stream to the user's downlink UE device 110.

Process 1000 may further include receiving a control action instruction from the UE device (block 1050) and performing a control action on a video stream, or on the combined video stream, based on the received control action instruction (block 1060). For example, VMS 155 may receive an instruction from UE device 110 to perform a control action and, in response, perform a control action. The control action may include, for example, selecting or changing a primary stream from the multiple video stream and increasing a size of a window of the primary stream in the combined video stream, adjusting the size of a window for a video stream in the combined video stream, generating a highlight reel for the combined video stream, and/or to performing another type of control action.

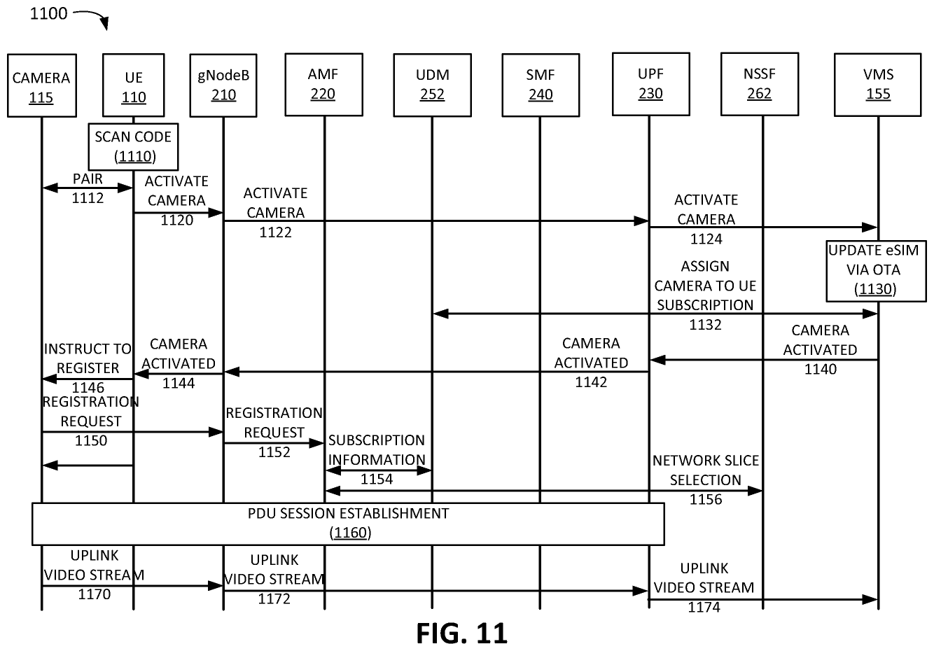

FIG. 11 illustrates an exemplary signal flow 1100 according to an implementation described herein. Signal flow 110 does not illustrate all signals sent during the process described below. For example, calls to NRF 258 to identify an appropriate NF for a particular service are not shown. As shown in FIG. 11, signal flow 1100 may include UE device 110 scanning scannable code 520 on camera 115 (block 1110). In response, UE device 110 may pair with camera 115 (signal 1112) and send a request to VMS 155 via gNodeB 210 and UPF 230 to activate and register camera 115 (signals 1120, 1122 and 1124). In response, VMS 155 may instruct OTA system 160 (not shown in FIG. 11) to update eSIM 560 on camera 115 (block 1130).

Furthermore, VMS 155 may send an instruction to UDM 252 to assign the camera to a subscription associated with UE device 110 (signal 1132). VMS 155 may first assign, or obtain from another device or system in core network 140, an IMSI, MDN, and/or another type of subscription ID to camera 115 and include the assigned subscription ID in the request to UDM 252. Additionally, VMS 155 may check with NSSF 262 that an uplink streaming network slice has been enabled for core network 150 (not shown in FIG. 11). VMS 155 may instruct UDM 252 to include the uplink streaming network slice on the allowed network slices list for camera 115. In response, UDM 252 may generate a subscription record for camera 115 and assign the subscription for camera 115 to UE device 110.

VMS 155 may further send an indication that camera 115 has been activated to UE device 110 via UPF 230 and gNodeB 210 (signals 11440, 1142, and 1144). In response, connected cameras application 400 on UE device 110 may instruct camera 115 to send a registration request to core network 150 (signal 1146). In response, camera 115 may send a registration request to AMF 220 via gNodeB 210 (signals 1150 and 1152) using the authentication credentials stored in eSIM 560. AMF 220 may obtain subscription information for camera 115 from UD 252 and confirm the network slice selection with NSSF 262 (signals 1154 and 1156). AMF 220 may assign camera 115 to the uplink streaming network slice. In some implementations, the uplink streaming network slice may be associated with a different AMF 220 and the registration procedure may be passed on to the other AMF 220 associated with the uplink streaming network slice.

AMF 220 may then perform a PDU session establishment to establish a PDU session for camera 115 on the uplink streaming network slice (block 1160). As part of the PDU session establishment, SMF 240 may assign UPF 230 to camera 115 and UPF 230 may serve as a gateway to VMS 155. Furthermore, a default data flow may be created in the established PDU session for uplink streaming of video. PCF 254 may provide policies for the established PDU session and/or created data low to SMF 240 and SMF 240 may apply the provided policies to UPF 230. The provided policies may assign an uplink streaming QoS class (e.g., a 5QI, etc.) to the created data flow. Camera 115 may then begin to stream uplink video to VMS 155 via gNodeB 210 and UPF 230 (signals 1170, 1172, ad 1174). VMS 155 may receive the uplink video stream, store the uplink video stream in a storage location associated with UE device 110, combine the uplink video stream with uplink video streams from other cameras 115, multicast the uplink video stream (or a combined uplink video stream) to downlink UE devices 110, and/or perform other control actions on the received uplink video stream.

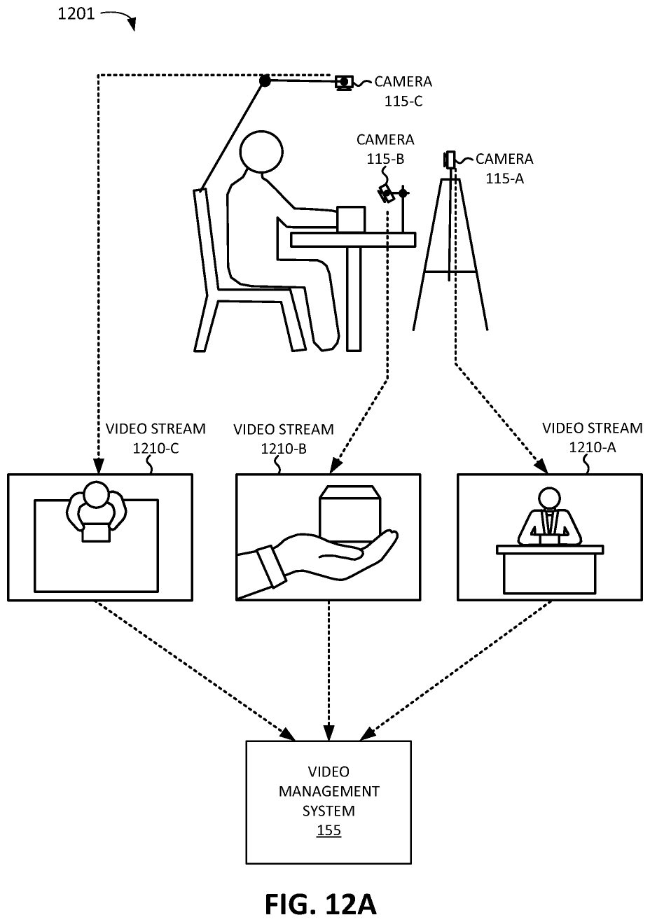

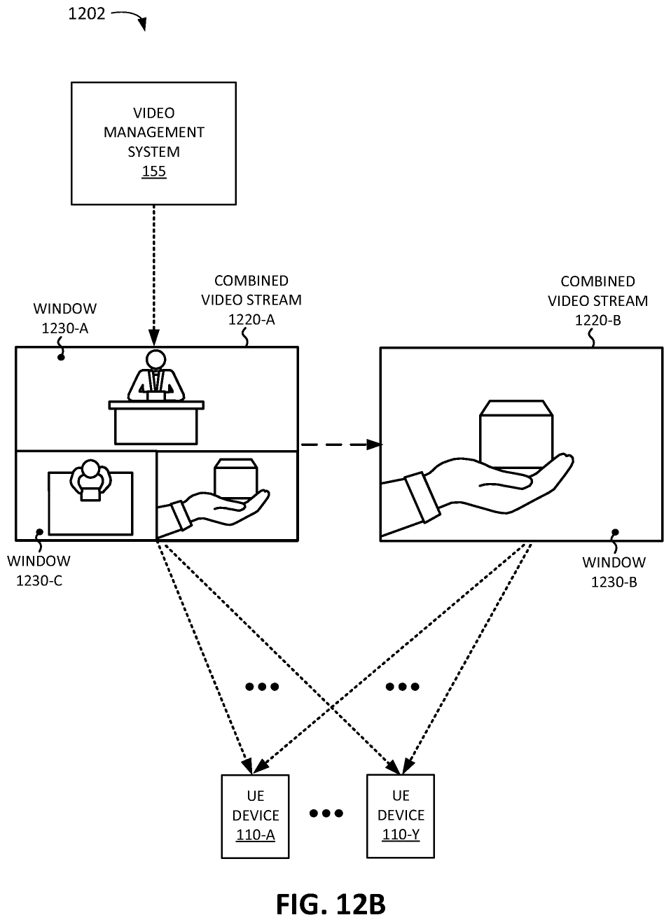

FIGS. 12A and 12B illustrate exemplary video streams according to an implementation described herein. FIG. 12A illustrates an environment 1201 with a user seated at a desk and reviewing a product for the user's followers (e.g., other users subscribed to the user's video channel, etc.). Environment 1201 may include camera 115-A facing the user, camera 115-B focused on the user's hands and the product the user is reviewing, and camera 115-C pointing down at the user and the desk for a top-down view. Cameras 115-A, 115-B, and 115-C may each be activated and registered with core network 150 and assigned to a subscription associated with the user and the user's UE device 110 (not shown in FIG. 12A). Camera 115-A may generate an uplink video stream 1210-A to VMS 155. Camera 115-B may generate an uplink video stream 1210-B to VMS 155. Camera 115-C may generate an uplink video stream 1210-C to VMS 155.

FIG. 12B illustrates a process 1202 associated with environment 1201 of FIG. 12B. As shown in FIG. 12A, process 1202 includes VMS 155 generating a combined video stream 1220-A that is streamed to downlink UE device 110-A to 110-Y associated with the user's followers. Combined video stream 1220-A may include a window 1230-A that displays video from uplink video stream 1210-A, window 1230-B that displays video from uplink video stream 1210-B, and window 1230-C that displays video from uplink video stream 1210-C. Uplink video stream 1210-A may be designated as the default primary video stream.

VMS 155 may be configured to monitor user behavior and to switch to uplink video stream 1210-B as the primary video stream if the user's hands, or an object held by the user, exhibit motion that exceeds a motion threshold. In response to detecting hand movements by the user, VMS 155 may switch to uplink video stream 1210-B as the primary stream. VMS 155 may increase the size of window 1230-B and reduce the size of windows 1230-A and 1230-C. VMS 155 may detect user hand movement that exceeds a second movement threshold and increase the size of window 1230-B to take up the entirety of the combined video stream to generate combined video stream 1220-B and may maintain combined video stream 1220-B until the user's hands and/or the object held by the user stops moving, at which point VMS 155 may switch back to combined video stream 1220-A.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIGS. 7, 8, 9, and 10, and a series of signals have been described with respect to FIG. 11, the order of the blocks and/or signals may be modified in other implementations. Further, non-dependent blocks and/or signals may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store, or employ personal information of individuals, it should be understood that such information shall be collected, stored, and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
registering, by one or more network devices, a camera device with a core network;
assigning, by the one or more network devices, the camera device to a subscription of a user equipment (UE) device registered with the core network;
assigning, by the one or more network devices, the camera device to an uplink streaming network slice;
assigning, by the one or more network devices, an uplink streaming video Quality of Service (QOS) class to a data flow sent from the camera device to the core network, wherein the uplink streaming video QoS class guarantees at least one video streaming QoS parameter; and
establishing, by the one or more network devices, the data flow from the camera device to a destination device via the uplink streaming network slice based on the uplink streaming video QoS class.

2. The method of claim 1, further comprising:
establishing, in the uplink streaming network slice, another data flow from the destination device to a downlink UE device, wherein the other data flow is assigned to a downlink streaming QoS class.

3. The method of claim 1, further comprising:
registering another camera device with the core network;
assigning the other camera device to the subscription associated with the UE device;
establishing another data flow from the other camera device to the destination device via the uplink streaming network slice based on the uplink streaming video QoS class; and
generating a downlink data flow from the destination device to a downlink UE device, wherein the downlink data flow combines video data from the data flow and the other data flow, and wherein the downlink data flow is assigned to a downlink streaming QoS class.

4. The method of claim 1, wherein the uplink streaming network slice enables a plurality of uplink video streams associated with a plurality of camera devices to be combined into a video stream controlled by the UE device.

5. The method of claim 1, further comprising:
performing an over-the-air (OTA) update for the camera device, wherein the OTA update is triggered by the UE device.

6. The method of claim 1, further comprising:
storing upstream video data received via the data flow from the camera device in a video folder associated with the subscription of the UE device.

7. The method of claim 1, wherein the destination device includes a video management system, the method further comprising:
receiving, by the video management system, an instruction from the UE device to perform a control action for a video stream associated with the data flow from the camera device; and
performing, by the video management system, the control action.

8. The method of claim 7, wherein performing the control action includes:
combining a plurality of uplink video streams associated with a plurality of camera devices into a combined video stream.

9. The method of claim 8, wherein performing the control action further includes:
selecting a primary stream from the plurality of uplink video streams; and
increasing a size of a window for the primary stream in the combined video stream, in response selecting the primary stream.

10. The method of claim 9, wherein selecting the primary stream from the plurality of uplink video streams includes:
monitoring user behavior based on the plurality of uplink video streams;
identifying a user trigger action in a particular stream of the plurality of uplink video streams; and
selecting the particular stream as the primary stream, in response to identifying the user trigger action.

11. The method of claim 7, wherein performing the control action includes:
generating a highlight reel for the video stream.

12. A system comprising:
one or more devices configured to:
register a camera device with a core network;
assign the camera device to a subscription of a user equipment (UE) device registered with the core network;
assign the camera device to an uplink streaming network slice;
assign an uplink streaming video Quality of Service (QOS) class to a data flow sent from the camera device to the core network, wherein the uplink streaming video QoS class guarantees at least one video streaming QoS parameter; and
establish the data flow from the camera device to a destination device via the uplink streaming network slice based on the uplink streaming video QoS class.

13. The system of claim 12, wherein the one or more devices are further configured to:
establish, in the uplink streaming network slice, another data flow from the destination device to a downlink UE device, wherein the other data flow is assigned to a downlink streaming QoS class.

14. The system of claim 12, wherein the one or more devices are further configured to:
register another camera device with the core network;
assign the other camera device to the subscription associated with the UE device;
establish another data flow from the other camera device to the destination device via the uplink streaming network slice based on the uplink streaming video QoS class; and
generate a downlink data flow from the destination device to a downlink UE device, wherein the downlink data flow combines video data from the data flow and the other data flow, and wherein the downlink data flow is assigned to a downlink streaming QoS class.

15. The system of claim 12, wherein the uplink streaming network slice enables a plurality of uplink video streams associated with a plurality of camera devices to be combined into a video stream controlled by the UE device.

16. The system of claim 12, wherein the one or more devices are further configured to:
store upstream video data received via the data flow from the camera device in a video folder associated with the subscription of the UE device.

17. The system of claim 12, wherein the destination device includes a video management system, and wherein the one or more devices are further configured to:
receive an instruction from the UE device to perform a control action for a video stream associated with the data flow from the camera device; and
perform the control action.

18. The system of claim 17, wherein, when performing the control action, the one or more devices are further configured to:
combine a plurality of uplink video streams associated with a plurality of camera devices into a combined video stream.

19. The system of claim 17, wherein, when performing the control action, the one or more devices are further configured to:
monitor user behavior based on the plurality of uplink video streams;
identify a user trigger action in a particular stream of the plurality of uplink video streams;
select the particular stream as a primary stream, in response to identifying the user trigger action; and
increase a size of a window for the primary stream in the combined video stream, in response selecting the primary stream.

20. A non-transitory computer-readable memory device storing instructions executable by a processor, the non-transitory computer-readable memory device comprising:
one or more instructions to register a camera device with a core network;
one or more instructions to assign the camera device to a subscription of a user equipment (UE) device registered with the core network;
one or more instructions to assign the camera device to an uplink streaming network slice;
one or more instructions to assign an uplink streaming video Quality of Service (QOS) class to a data flow sent from the camera device to the core network, wherein the uplink streaming video QoS class guarantees at least one video streaming QoS parameter; and
one or more instructions to establish the data flow from the camera device to a destination device via the uplink streaming network slice based on the uplink streaming video QoS class.
